(19) United States
(12) Patent Application Publication
(10) Pub. No.: US 2015/0317241 A1
(43) Pub. Date: Nov. 5, 2015

(54) TEST DESIGN ASSISTANCE DEVICE, TEST DESIGN ASSISTANCE METHOD, AND COMPUTER-READABLE MEDIUM

(71) Applicant: FUJI XEROX CO., LTD., Tokyo (JP)

(72) Inventor: Koichi AKIYAMA, Tokyo (JP)

(73) Assignee: FUJI XEROX CO., LTD., Tokyo (JP)

(21) Appl. No.: 14/796,087

(22) Filed: Jul. 10, 2015

Related U.S. Application Data
(63) Continuation of application No. PCT/JP2013/074266, filed on Sep. 9, 2013.

(30) Foreign Application Priority Data
Mar. 15, 2013 (JP) 2013-052740

(51) Int. Cl. G06F 11/36

(52) U.S. Cl. CPC G06F 11/3684; G06F 11/3664

(57) ABSTRACT

A test design assistance device 10 generates path information indicating a transition path based on a transition event with a designated state as a starting point in a state transition diagram in which the transition event transitioning from one state to the same or another state is described, sets each transition event included in the path information to a factor and sets a type of the transition event to a level, allocates sets of the set factors and levels to a matrix having a designated size, extracts a combination that does not appear in any row of the matrix to which the sets are allocated, among combinations pertaining to all levels between any plurality of factors included within a designated distance in the path information, and adds a row including the extracted combination to the matrix to thereby generate a test matrix.

### CROSS REFERENCE TO RELATED APPLICATION

This is a continuation of International Application No. PCT/JP2013/074266 filed on Sep. 9, 2013, and claims priority from Japanese Patent Application No. 2013-052740, filed on Mar. 15, 2013.

### BACKGROUND

1. Technical Field

The present invention relates to a test design assistance device, a test design assistance method, and a computer-readable medium.

2. Related Art

A test may be performed in order to confirm whether or not an abnormal action occurs due to a combination of settings between a plurality of factors in software or the like.

In addition, when one state transitions to another state due to an event in software or the like, a test for the state transition may be performed. In such a test, since the coverage of a combination of all state transitions results in a huge number of test cases, it is necessary to reduce the number of test cases. Here, it is considered that there is a tendency for an event close to one state transition event in a state transition diagram to affect the state transition event more than an event distant from the state transition event.

### SUMMARY

An aspect of the present invention provides a test design assistance device including: a first generation unit that generates path information indicating a transition path based on a transition event with a designated state as a starting point in a state transition diagram in which the transition event transitioning from one state to the same or another state is described; a first setting unit that sets each transition event included in the path information to a factor and sets a type of the transition event to a level; an allocation unit that allocates sets of the set factors and levels to a matrix having a designated size; an extraction unit that extracts a combination that does not appear in any row of the matrix to which the sets are allocated, among combinations pertaining to all levels between any plurality of factors included within a designated distance in the path information; and a second generation unit that adds a row including the extracted combination to the matrix to thereby generate a test matrix.

### BRIEF DESCRIPTION OF THE DRAWINGS

Exemplary embodiment(s) of the present invention will be described in detail based on the following figures, wherein

FIG. 1 is a functional block diagram of a test design assistance device according to this embodiment;

FIG. 2 is a diagram showing an example of a state transition diagram;

FIG. 3A is a diagram showing an example in which transition events in the state transition diagram are integrated;

FIG. 3B is a diagram showing an example in which transition events in the state transition diagram are integrated;

FIG. 4A is a diagram showing an example of a transition path;

FIG. 4B is a diagram showing an example of factors and levels which are set with respect to a transition path;

FIG. 5 is a diagram showing an example of an interface that receives the designation of an orthogonal table size;

FIG. 6 is a diagram showing an example showing factors and levels which are allocated to a test matrix (matrix);

FIG. 7 is a diagram showing a round robin table of the test matrix of FIG. 6;

FIG. 8 is a diagram showing an example of an interface for designating a coverage distance;

FIG. 9 is a diagram showing an example of coverage conditions;

FIG. 10 is a diagram showing sets of factors and levels which are extracted in the round robin table of FIG. 7;

FIG. 11 is a diagram showing an example of a test matrix;

FIG. 12 is a diagram showing a round robin table of the test matrix of FIG. 11;

FIG. 13 is a flow chart of a process which is performed by a test design assistance device; and

FIG. 14 is a flow chart of a process which is performed by a test design assistance device.

### DETAILED DESCRIPTION

Hereinafter, an exemplary embodiment for carrying out the present invention (hereinafter, referred to as embodiment) will be described with reference to the accompanying drawings.

### 1. Description of Functions Included in Test Design assistance Device 10

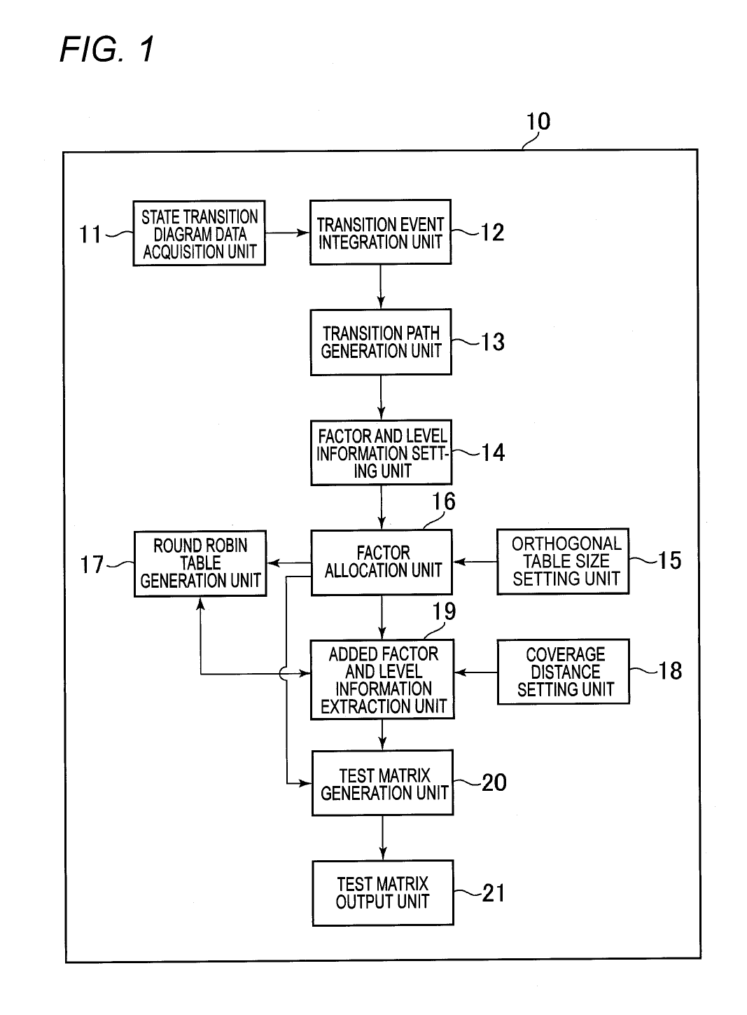

FIG. 1 shows a functional block diagram of a test design assistance device 10 according to this embodiment. As shown in FIG. 1, the test design assistance device 10 includes a state transition diagram data acquisition unit 11, a transition event integration unit 12, a transition path generation unit 13, a factor and level information setting unit 14, an orthogonal table size setting unit 15, a factor allocation unit 16, a round robin table generation unit 17, a coverage distance setting unit 18, an added factor and level information extraction unit 19, a test matrix generation unit 20, and a test matrix output unit 21. Meanwhile, the test design assistance device 10 according to this embodiment generates a test matrix in which a set of levels of the respective factors of a test target is shown in each row when performing a test for software. That is, one row of the test matrix corresponds to one test case.

The functions of the above-mentioned units included in the test design assistance device 10 may be realized by causing a computer including control member such as a CPU, storage member such as a memory, input and output member for transmitting and receiving data to and from an external device, and the like to read and execute a program stored in a computer-readable information storage medium. Meanwhile, the program may be supplied to the test design assistance device 10 which is a computer by an information storage medium such as an optical disc, a magnetic disk, a magnetic tape, a magneto-optical disk, or a flash memory, or may be supplied to the test design assistance device 10 through a data communication network such as the Internet.

The state transition diagram data acquisition unit 11 acquires data of a state transition diagram including plural states and information of an event which transitions from one state in the plural states to the same or another state. For example, the state transition diagram data acquisition unit 11 may acquire data of the state transition diagram on the basis of data input from an input device such as a keyboard or a mouse or an external device.

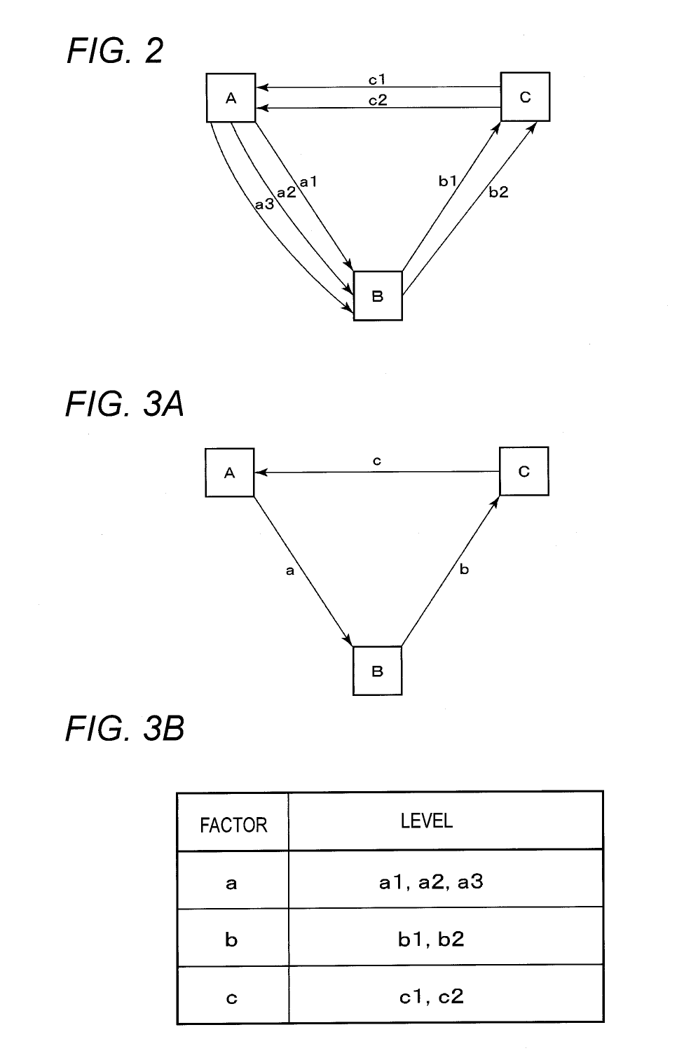

FIG. 2 shows an example of a state transition diagram. The state transition diagram shown in FIG. 2 includes states A, B, and C and shows that the state A transitions to the state B by an event a1, a2, or a3, the state B transitions to the state C by an event b1 or b2, and the state C transitions to the state C by an event c1 or c2.

When there are a plurality of (types of) events transitioning from a first state to a second state in the state transition diagram acquired by the state transition diagram data acquisition unit 11, the transition event integration unit 12 integrates the events into one transition event and sets the plurality of events to have a level value of the transition event. That is, in this embodiment, the type of the transition event refers to each of the events integrated into the transition event.

FIGS. 3A and 3B show an example in which transition events in the state transition diagram shown in FIG. 2 are integrated. As shown in FIG. 3A, for example, the events a1, a2, and a3 transitioning from the state A to the state B are shown as a transition event a, the events b1 and b2 transitioning from the state B to the state C are shown as a transition event b, and the events c1 and c2 transitioning from the state C to the state A are shown as a transition event c. As shown in FIG. 3B, levels a1, a2, and a3 are set with respect to the factor a, levels b1 and b2 are set with respect to the factor b, and levels c1 and c2 are set with respect to the factor c, as levels of the transition events (factors).

The transition path generation unit 13 generates a transition path for covering state transitions in a state transition diagram in which transition events are integrated. For example, the transition path generation unit 13 may generate a transition path by N switch coverages (N is an integer of 0 or greater).

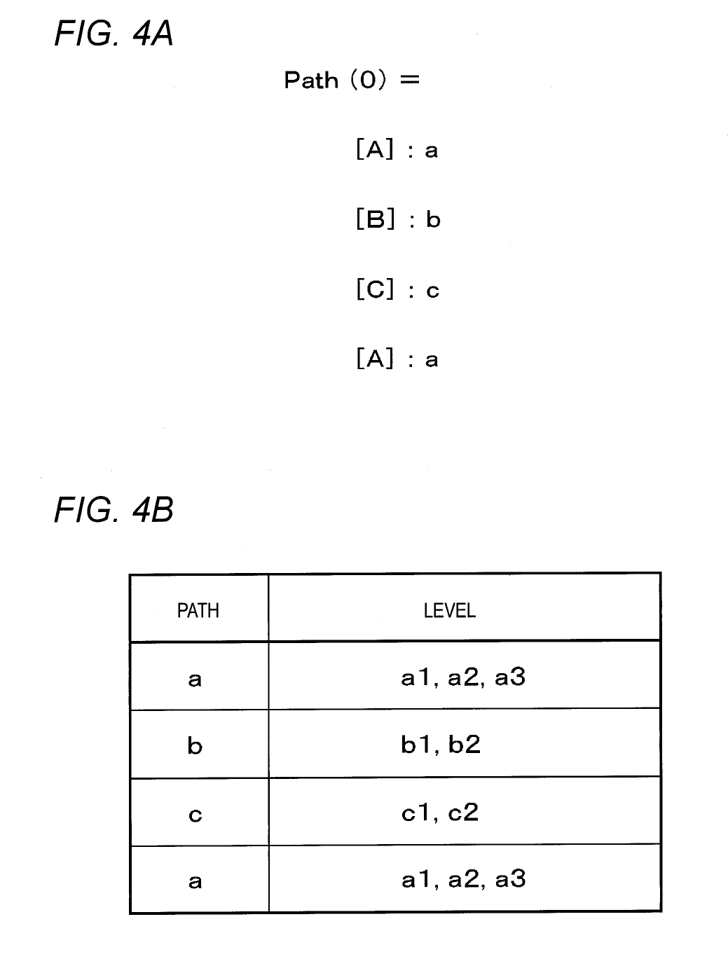

FIG. 4A shows an example of a transition path which is generated in the state transition diagram shown in FIG. 3A. The transition path shown in FIG. 4A is information indicating that the state A transitions to the state B by the transition event a, the state B transitions to the state C by the transition event b, and the state C transitions to the state A by the transition event c with the state A as a starting point, and thus all of the states and the state transitions are covered.

The factor and level information setting unit 14 sets a transition event to a factor and sets an event included in the transition event to a level on the basis of the transition path generated by the transition path generation unit 13.

FIG. 4B shows an example of factors and levels which are set with respect to the transition path shown in FIG. 4A.

The orthogonal table size setting unit 15 sets the size of an orthogonal table (matrix) serving as the basis for the allocation of factors set by the factor and level information setting unit 14. Meanwhile, the orthogonal table refers to a matrix A in a case where all of λ ordered pairs S×S={(0, 0), (0, 1), . . . , (0, (s−1)), (1, 0), (1, 1), . . . , ((s−1), (s−1))} are exactly shown with respect to any two columns of A when the matrix A having λ×s² rows and m columns with respect to a set S={0, 1, 2, . . . , s−1} of positive integers is considered. In addition, an L₄ orthogonal table is an orthogonal table having four rows and three columns.

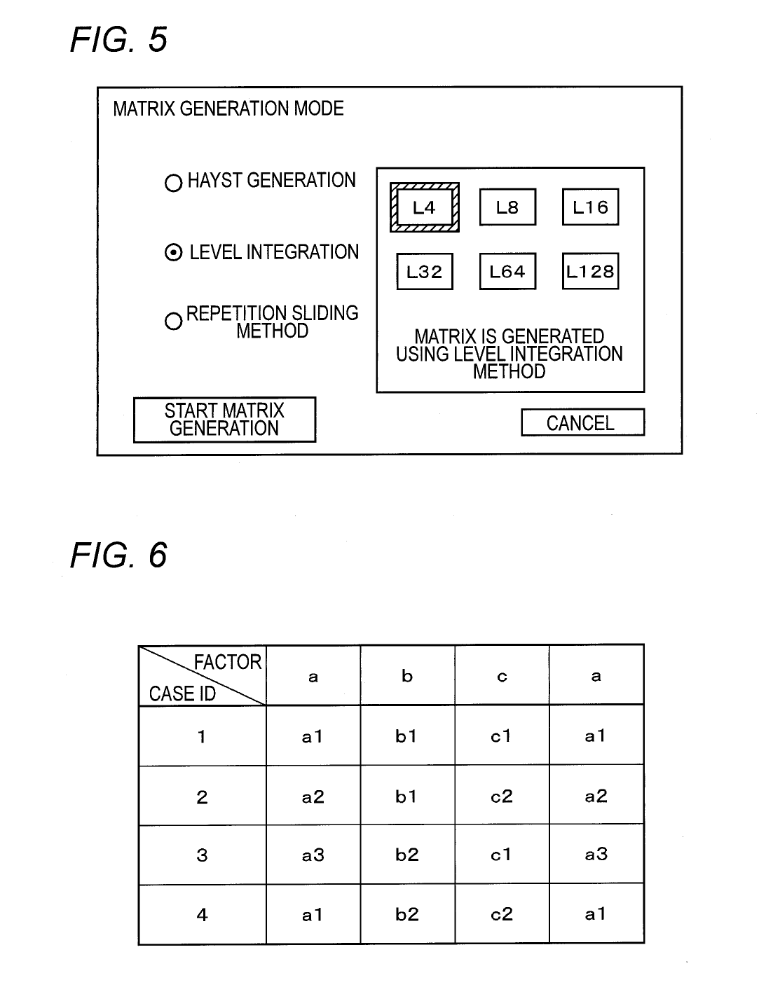

FIG. 5 shows an example of an interface that receives the designation of an orthogonal table size. FIG. 5 shows an example in which a level integration method and an L₄ orthogonal table are selected. In this manner, the orthogonal table size setting unit 15 may set the size of an orthogonal table on the basis of information which is input on a setting screen.

The factor allocation unit 16 allocates factors which are set by the factor and level information setting unit 14 to a matrix which is generated on the basis of an orthogonal table having a size set by the orthogonal table size setting unit 15. For example, the factor allocation unit 16 may generate a table which is laterally connected to the orthogonal table having a size set by the orthogonal table size setting unit 15 (that is, may expand a table using a level integration method) and may allocate factors to the generated table.

FIG. 6 shows an example of factors and levels which are allocated to a test matrix (matrix) based on the L₄ orthogonal table using a level integration method by the factor allocation unit 16. Each row in the test matrix corresponds to one test case of a state transition test.

The round robin table generation unit 17 generates a round robin table of factors and levels which are allocated to the test matrix by the factor allocation unit 16.

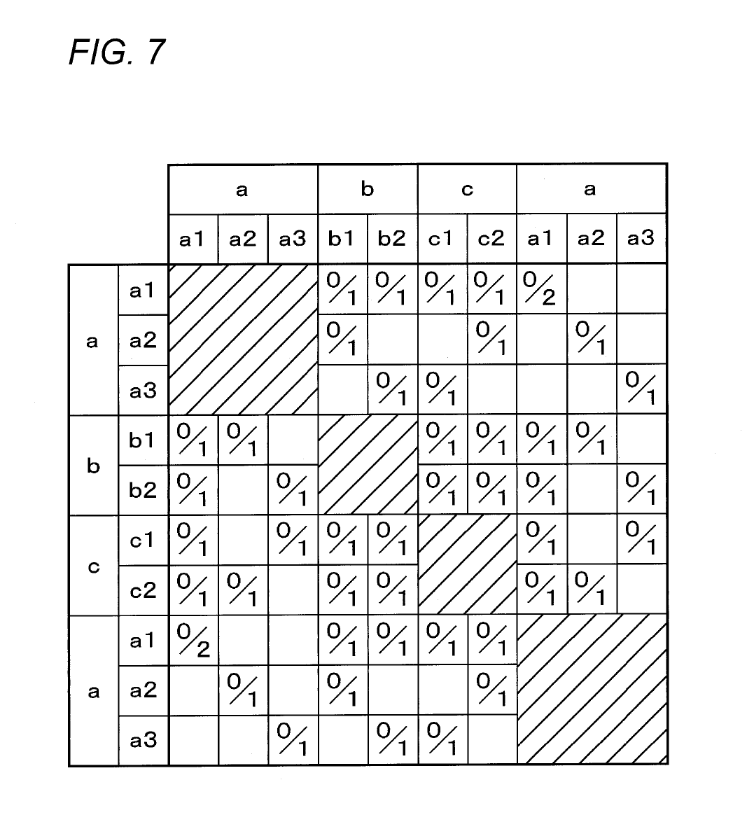

FIG. 7 shows an example of a round robin table which is generated by the round robin table generation unit 17 with respect to the allocation example of FIG. 6. Meanwhile, in the round robin table shown in FIG. 7, a location where I/J is not written indicates a combination of a factor and a level which are not covered, and a location where I/J is written indicates a combination of a factor and a level which are covered. Here, J may indicate the number of appearances in a test case, and I may indicate the number of bugs in a test.

The coverage distance setting unit 18 sets a set of all transition events transitioning to other states which are present within a distance which is designated with respect to any state, as a combination of transition events to be covered in a transition path of a test target. For example, when a distance of 1 is designated, a set of transition events between any state and a state having a distance of 1 with respect to the state, for example, a relationship between a transition event I transitioning from a state i to a state (i+1) with respect to the state i and a transition event (I−1) transitioning from a state (i−1) to the state i is covered. In addition, when a distance d is designated, a relationship between one factor and another factor which is connected thereto through (d−1) factors or less is covered in the transition path.

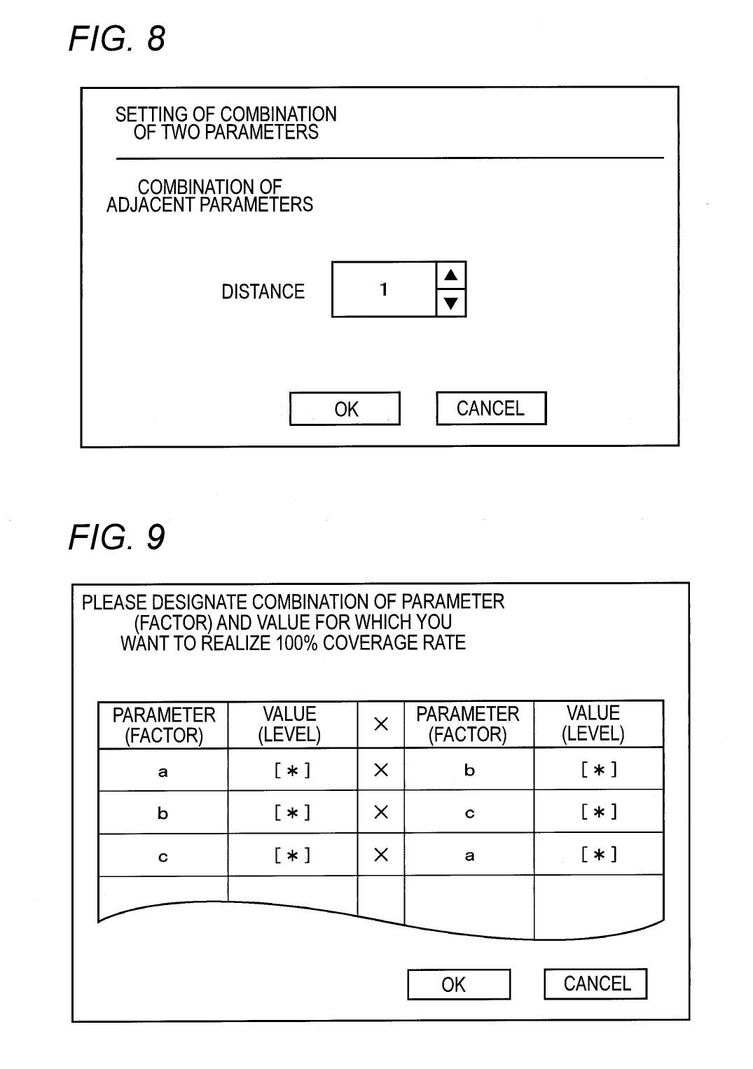

FIG. 8 shows an example of an interface for designating a coverage distance. In an example of a setting screen shown in FIG. 8, a distance of a combination of two states (two parameters) to be covered can be designated. The coverage distance setting unit 18 may set the distance designated on the setting screen to a coverage distance.

The added factor and level information extraction unit 19 generates a condition for combining factors and levels to be covered (coverage condition) on the basis of the coverage distance set by the coverage distance setting unit 18, and extracts a combination of a factor and a level which are not allocated by the factor allocation unit 16 which is a set of a factor and a level which coincide with the generated condition.

FIG. 9 shows an example of a coverage condition. The coverage condition shown in FIG. 9 is generated in a case where a coverage distance of 1 is set in the state transition diagram shown in FIG. 3A. The coverage condition shown in FIG. 9 is a condition in which a combination of any values of a factor (transition event) a and a factor (transition event) b, a combination of any values of the factor (transition event) b and a factor (transition event) c, and a combination of any values of the factor (transition event) c and the factor (transition event) a are one hundred percent covered.

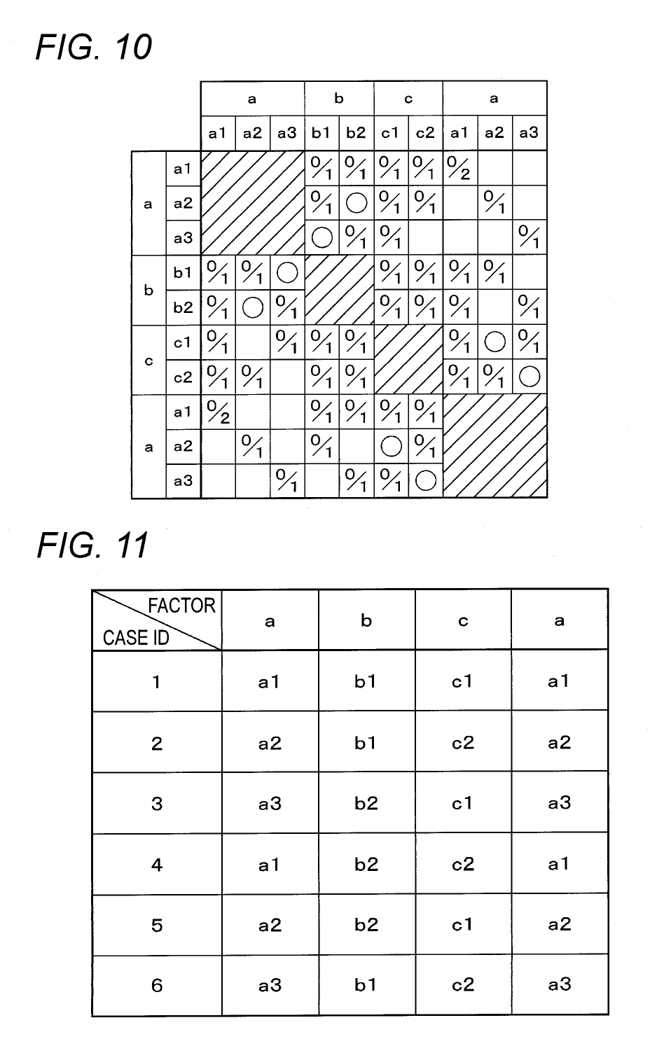

The added factor and level information extraction unit 19 extracts a set of a factor and a level which are not allocated by the factor allocation unit 16 which is a set of a factor and a level which satisfies a coverage condition, for example, from the round robin table generated by the round robin table generation unit 17. In FIG. 10, a set of a factor and a level which is extracted in the round robin table shown in FIG. 7 by the added factor and level information extraction unit 19 is indicated by a circle mark.

The test matrix generation unit 20 generates a test matrix satisfying a designated condition by adding an addition row based on the set of a factor and a level, which is extracted by the added factor and level information extraction unit 19, to a basic test matrix based on the orthogonal table having a size designated by the orthogonal table size setting unit 15.

FIG. 11 shows an example of the test matrix generated by the test matrix generation unit 20. In the example shown in FIG. 11, rows having test case IDs of 5 and 6 are added to the basic test matrix shown in FIG. 6. Here, the added rows are (a2, b1, c1, a2) and (a3, b1, c2, a3) which cover (a2, b1) and (a3, b1) with respect to the factor a and the factor b and (c1, a2) and (c2, a3) with respect to the factor c and the factor a shown in FIG. 10.

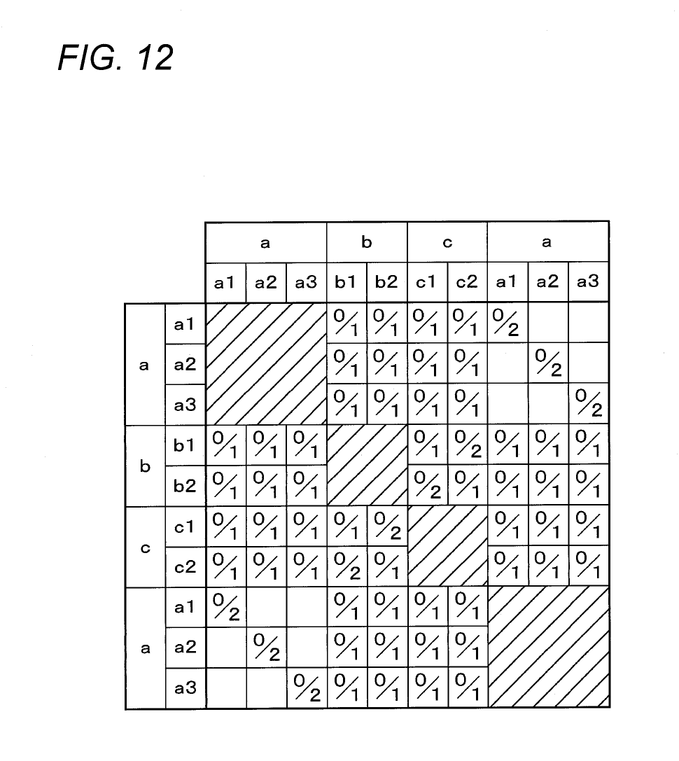

FIG. 12 shows a round robin table of the test matrix generated by the test matrix generation unit 20. As shown in FIG. 12, in the test matrix generated by the test matrix generation unit 20, a coverage rate of a combination of factors adjacent to each other is set to 100%.

The test matrix output unit 21 outputs the test matrix generated by the test matrix generation unit 20. For example, the output of the test matrix may include a display of the test matrix on a display device, the data transmission of the test matrix, the printing and output of the test matrix, and the like.

### 2. Description of Process Performed by Test Design assistance Device 10

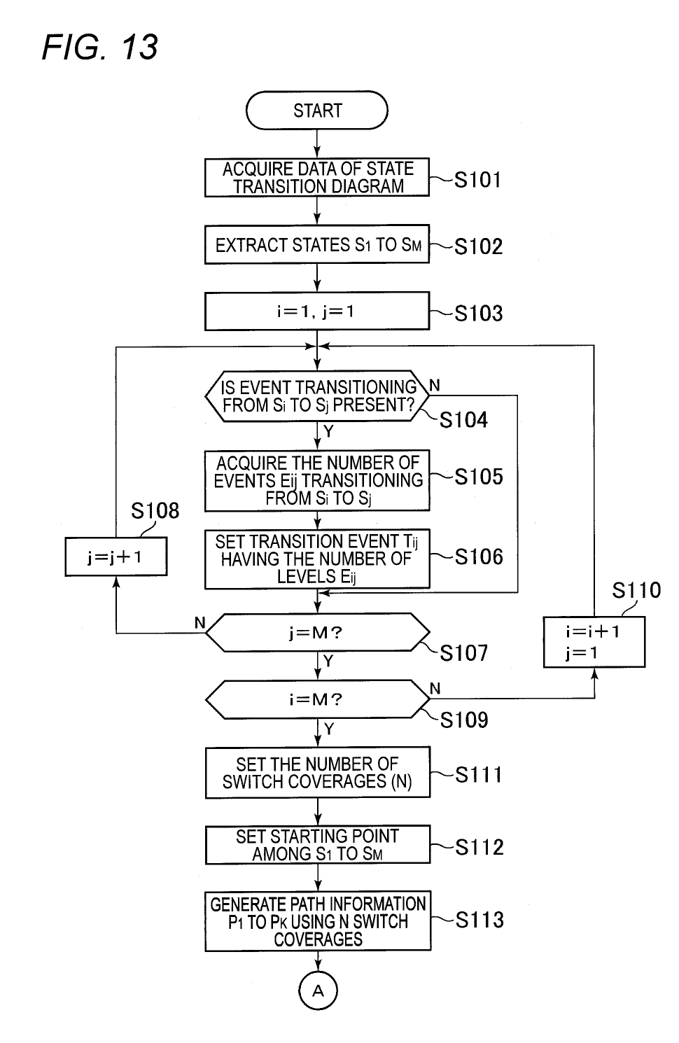

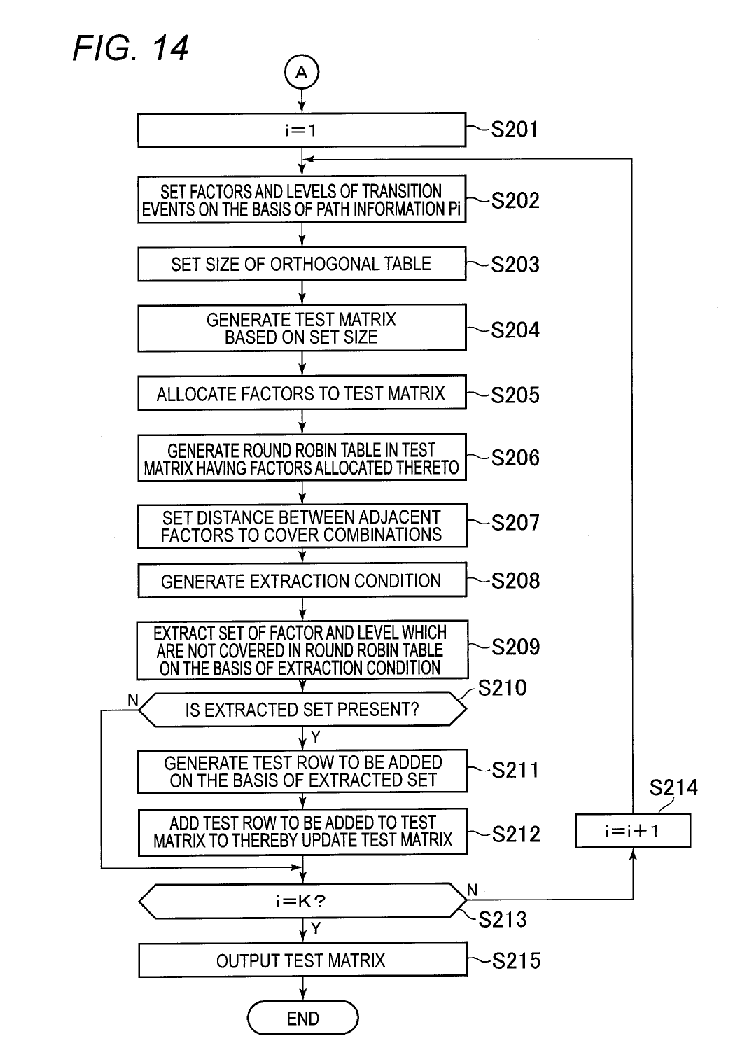

Next, processes performed by the test design assistance device 10 will be described in detail with reference to flow charts shown in FIGS. 13 and 14.

As shown in FIG. 13, the test design assistance device 10 acquires data of a state transition diagram (for example, data of FIG. 2 and the like) (S101), and extracts all states (S₁ to S_{M}) which are included in the acquired state transition diagram (S102).

The test design assistance device 10 initializes variables i and j to 1 (S103). When an event transitioning from Sᵢ to Sⱼ is present (S104: Y), the test design assistance device acquires the number of events Eᵢⱼ transitioning from Sᵢ to Sⱼ (S105) and sets a transition event (factor) Tᵢⱼ having the acquired number of events as the number of levels (S106).

When an event transitioning from Sᵢ to Sⱼ is not present (S104: N) or when the variable j does not reach M after S106 (S107: N), the test design assistance device 10 increments j (adds 1 to j) (S108) and returns to S104. In addition, when variable j reaches M in S107 (S107: Y), the test design assistance device 10 proceeds to S109.

When the variable i does not reach M in S109 (S109: N), the test design assistance device 10 initializes j to 1 and increments i (adds 1 to i) (S110) and returns to S104. In addition, when the variable i reaches M in S109 (S109: Y), the test design assistance device 10 proceeds to S111.

The test design assistance device 10 sets the number of switch coverages (N), for example, on the basis of data received from a user (S111) and sets a starting point (Sₚ) among the states S₁ to S_{M} (S112).

The test design assistance device 10 generates path information P₁ to Pₖ using the N switch coverages on the basis of the set starting point Sₚ and a transition event transitioning from Sₚ to another state (S113). The process of S113 and the subsequent processes will be described with reference to the flow chart shown in FIG. 14.

As shown in FIG. 14, the test design assistance device 10 initializes the variable i to 1 (S201) and sets factors and levels of transition events included in the path information Pᵢ on the basis of Pᵢ (S202).

Next, the test design assistance device 10 sets the size of an orthogonal table which is used, for example, on the basis of data received from a user (S203) and generates a test matrix based on the orthogonal table having the set size (S204). For example, the test design assistance device 10 may generate a test matrix in which two orthogonal tables having a size set using a level integration method are laterally connected to each other. The test design assistance device 10 allocates factors set in S202 to the generated test matrix (S205).

Here, the test design assistance device 10 generates a round robin table (for example, see FIG. 7) with respect to the test matrix having factors allocated thereto, for example, in response to an instruction from a user (S206).

Next, the test design assistance device 10 sets a distance between factors to cover combinations one hundred percent among transition events (factors) between states included in the path information Pi, for example, in accordance with data received from a user (S207), and generates an extraction condition for extracting combinations of factors required to be added which are combinations of factors within the set distance (S208). For example, the extraction condition may be a condition for extracting combinations which are not allocated in S205 among combinations of all levels of a plurality of factors within the distance set in S207.

The test design assistance device 10 extracts a set of a factor and a level, for example, from the round robin table generated in S206 on the basis of the extraction condition generated in S208 (S209).

Here, when the set of a factor and a level which is extracted in S209 is present (S210: Y), the test design assistance device 10 generates a test row to be added, on the basis of the extracted set of a factor and a level (S211) and adds the generated test row to the test matrix generated in S204 to thereby update the test matrix (S212).

When the set of a factor and a level which is extracted in S209 is not present (S209: N) or after S212, the test design assistance device 10 proceeds to S213.

When the variable i does not reach k in S213 (S213: N), the test design assistance device 10 increments i (adds 1 to i) (S214) and returns to S202. When the variable i reaches k (S213: Y), the test design assistance device outputs the generated test matrix (S215) and terminates the process.

The invention is not limited to the above-described embodiment. In addition, factors, corresponding to the number of levels of each column of a test matrix generated by the test design assistance device 10 mentioned above, and specific values of the levels may be allocated to each column, and test cases for the respective rows of the test matrix may be sequentially performed.

### INDUSTRIAL APPLICABILITY

A test design assistance device, a test design assistance method, a program, and a computer-readable medium according to the invention are useful, for example, in verifying an operation of software.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A test design assistance device comprising:
a first generation unit that generates path information indicating a transition path based on a transition event with a designated state as a starting point in a state transition diagram in which the transition event transitioning from one state to the same or another state is described;
a first setting unit that sets each transition event included in the path information to a factor and sets a type of the transition event to a level;
an allocation unit that allocates sets of the set factors and levels to a matrix having a designated size;
an extraction unit that extracts a combination that does not appear in any row of the matrix to which the sets are allocated, among combinations pertaining to all levels between any plurality of factors included within a designated distance in the path information; and
a second generation unit that adds a row including the extracted combination to the matrix to thereby generate a test matrix.

2. The test design assistance device according to claim 1, wherein the distance is information indicating 1 when two attention-attracting factors are adjacent to each other in the path information and is information indicating (i+1) when the two factors are connected to each other through i factors (i is an integer).

3. The test design assistance device according to claim 1, further comprising a second setting unit that sets a plurality of events to one transition event and sets the plurality of events to a type of the transition event when the plurality of events transitioning from any first state to any second state are present in the state transition diagram.

4. The test design assistance device according to claim 1, wherein the allocation unit allocates sets of the set factors and levels to a matrix in which an orthogonal table having a designated size is expanded.

5. A test design assistance method causing a computer to execute a process, the process comprising:
generating path information indicating a transition path based on a transition event with a designated state as a starting point in a state transition diagram in which the transition event transitioning from one state to the same or another state is described;
setting each transition event included in the path information to a factor and sets a type of the transition event to a level;
allocating sets of the set factors and levels to a matrix having a designated size;
extracting a combination that does not appear in any row of the matrix to which the sets are allocated, among combinations pertaining to all levels between any plurality of factors included within a designated distance in the path information; and
adding a row including the extracted combination to the matrix to thereby generate a test matrix.

6. A non-transitory computer readable medium storing a program causing a computer to execute a process, the process comprising:
generating path information indicating a transition path based on a transition event with a designated state as a starting point in a state transition diagram in which the transition event transitioning from one state to the same or another state is described;
setting each transition event included in the path information to a factor and sets a type of the transition event to a level;
allocating sets of the set factors and levels to a matrix having a designated size;
extracting a combination that does not appear in any row of the matrix to which the sets are allocated, among combinations pertaining to all levels between any plurality of factors included within a designated distance in the path information; and
adding a row including the extracted combination to the matrix to thereby generate a test matrix.
